(19) United States
(12) Patent Application Publication
(10) Pub. No.: US 2003/0154137 A1
(43) Pub. Date: Aug. 14, 2003

(54) Method of operating a service

(76) Inventors: Jeremy John Carroll, Bristol (GB); Andrew Franklin Seaborne, Bristol (GB); Steven Andrew Battle, Bristol (GB)

Correspondence Address: HEWLETT-PACKARD COMPANY, Intellectual Property Administration, P.O. Box 272400, Fort Collins, CO, 80527-2400, US

(21) Appl. No.: 10/075,526

(22) Filed: Feb. 13, 2002

(51) Int. Cl. G06F 17/60

(52) U.S. Cl. 705/26

(57) ABSTRACT

A method of operating a service over a computer network which has a customer and a vendor which negotiate during a contract formation phase of a transaction and in which a product or service is supplied to the customer during a contract execution phase of the transaction, there being a customer interface between the customer and the network to enable messages transmitted on the network according to a network protocol to be utilised by the customer, and to enable messages originating from the customer to be transmitted onto the network according to the network protocol, and a vendor interface between the vendor and the network to enable messages transmitted on the network according to a network protocol to be utilised by the vendor and to enable messages originating from the vendor to be transmitted onto the network according to the network protocol, and wherein the method includes differentiating messages relating to contract formation and contract execution phases of the transaction, messages relating to the contract formation phase of the transaction being enabled for transmission onto the network or for utilisation by the customer or vendor by a first sub-interface of the respective customer or vendor interface, and messages relating to the contract execution phase of the transaction being enabled for transmission onto the network or for utilisation by the customer or vendor by a second sub-interface of the respective customer or vendor interface.

### BACKGROUND TO THE INVENTION

This invention relates to a method of operating a service, an architecture for a service, an interface for a service and a network protocol for a service, most particularly where the service is an e-service.

An e-service is a service invoked over a computer network, for which there is accounting so that a seller providing a product or service can identify the buyer and achieve payment for the service or product the seller supplies. In respect of any e-service transaction, there is a contract formation phase during which an e-vendor typically a network enabled device of a product or service seller, negotiates with an e-customer which typically is a network enabled device of a product or service buyer, and a contract execution phase during which the seller provides the product or service to the buyer.

The buyer may be a consumer of the product or service or an intermediary with whom the seller is contracted to supply the product or service; the seller may be an originator of the product or service, such as a manufacturer of a product, or may be an intermediary with whom the buyer enters a contract for the supply of the product or service. Other complex e-service supply chains are possible involving any number parties to any e-transaction. The party to the e-service requiring a product or service will hereinafter be referred to as an e-customer, and any party with whom the e-customer communicates for the purposes of the transaction will hereinafter be referred to an the e-vendor, although the e-vendor may not be the eventual supplier of the product or service to the e-customer.

To enable an e-customer to communicate over the network with an e-vendor, when the e-customer's and e-vendor's network enabled devices may be incompatibly programmed. Typically the e-customer's and e-vendor's computer enabled devices each includes an interface including an Interface Definition Language (IDL) compiler to enable messages created by the e-customer's or e-vendor's network enabled devices to be transmitted over the network according to a network protocol, and an IDL interpreter to enable messages transmitted on the network to be utilised by the e-vendor's or e-customer's network enabled device respectively.

### DESCRIPTION OF THE PRIOR ART

For example a common network protocol utilised for the Internet is TCP/IP. This is a general protocol which permits general communications over the Internet between a wide variety of different kinds and species of network enabled devices. A network protocol which is used more specifically in e-service transactions is E-Speak. Like CORBA (Common Object Request Broker Architecture) as specified by the object management group in specifications available at http://www.omg.org, E-speak is furnished with an IDL and an IDL compiler. The IDL specifies a network protocol in terms of the higher level concepts corresponding to function call in a programming language. The IDL compiler implements these high level concepts as a network protocol typically over TCP/IP and with language stubs (e.g. in Java) corresponding to the natural mapping of the IDL into the function call or method call of the target programming language.

This allows E-Speak components readily to match messages on the network with functions to be invoked, either remotely by a peer on behalf of the local process, or by the local process on behalf of a remote peer. However, these functions and the related protocol is typically specified as a single interface: E-Speak and CORBA components either implement all the functions or none of them. In the cases when interfaces are broken down into sub-interfaces, business criteria are not the primary criteria for determining which functions go into which sub-interfaces.

Thus at both the lower TCP/IP layer or the higher more abstract E-Speak layer there is no systematic differentiation of messages between the different business phases of the interaction. The two critical business phases identified in this invention are contract formation, during which a legally binding agreement is reached, and contract execution, during which that agreement is fulfilled.

Conventionally, any other party or potential party to the transaction, e.g. another service provider, which may be concerned only or primarily with the contract formation phase or the contract execution phase of an e-service transaction, cannot differentiate between messages relating to either or both of these transactions, from the network protocol, but only from examining the content of such messages which most likely will require human interaction.

It is known in non e-service supply chains in business transactions, for the contract formation phase of the transaction to be negotiated between specialist buyer and seller personnel, and for the contract execution phase of the transaction to be performed by separate specific product or service provider personnel such as for example only in the case of a service, an engineer. Queries in relation to the supply of the product or service are dealt with by the provider personnel, often without reference to the contract negotiated between the buyer and seller personnel.

Also, such versatile non e-service supply chains allow flexible chains of intermediaries concerned only with contract formation (e.g. brokers), and independent chains of sub-contractors who execute the contracts, possibly themselves working under an unrelated back contract, in which case they typically do not participate in the contract formation.

Such non e-service supply chains are expensive to operate particular in terms of labour costs and economic friction by which we mean that having established a supply chain, it may be less expensive in terms of trouble and cost to continue to use a not-entirely satisfactory supplier in the supply chain, than to seek an alternative supplier and negotiate new supply chain terms. An e-service of the kind with which this invention is concerned reduces economic friction and the costs of setting up a supply chain, so that individual supply chains for individual e-transaction may be established. This lower friction should result in more efficient market operation and hence lower transaction costs.

### SUMMARY OF THE INVENTION

According to a first aspect of the invention we provide a method of operating an e-service over a computer network which has an e-customer and an e-vendor which negotiate during a contract formation phase of an e-transaction and in which a product or service is supplied to the e-customer during a contract execution phase of the e-transaction, there being an e-customer interface between the e-customer and the network to enable messages transmitted on the network according to a network protocol to be utilised by the e-customer, and to enable messages orginating from the e-customer to be transmitted onto the network according to the network protocol, and an e-vendor interface between the e-vendor and the network to enable messages transmitted on the network according to a network protocol to be utilised by the e-vendor and to enable messages originating from the e-vendor to be transmitted onto the network according to the network protocol, and wherein the method includes differentiating messages relating to contract formation and contract execution phases of the e-transaction, messages relating to the contract formation phase of the e-transaction being enabled for transmission onto the network or for utilisation by the e-customer or e-vendor by a first sub-interface of the respective e-customer or e-vendor interface, and messages relating to the contract execution phase of the e-transaction being enabled for transmission onto the network or for utilisation by the e-customer or e-vendor by a second sub-interface of the respective e-customer or e-vendor interface.

Thus in accordance with the invention, messages relating to the contract formation phase of an e-transaction can be differentiated on the network from messages relating to the contract execution phase of the e-transaction. Thus an e-service provider involved in the transaction additional to the e-customer and e-vendor, but which may only or primarily be concerned with one or other of the contract formation and contract execution phases can differentiate and act upon messages relating only to the transaction phase of concern or prime concern.

Any additional e-service provider involved in the e-transaction during the contract negotiation phase of the transaction only but which plays no part in the contract execution phase of the e-transaction, may have an interface capable of implementing a first sub-interface functionality only to enable network messages relating only to the contract formation phase of the e-transaction to be utilised by the additional service provider or where created by the additional service provider, to enable these messages to be transmitted onto the network according to the network protocol.

According to a second aspect of the invention we provide an architecture for an e-service which operates over a computer network which has an e-customer and an e-vendor which negotiate during a contract formation phase of an e-transaction and in which a product or service is supplied to the e-customer during a contract execution phase of the e-transaction, there being an e-customer interface between the e-customer and the network to enable messages transmitted on the network according to a network protocol to be utilised by the e-customer and to enable messages originating from the e-customer to be transmitted onto the network according to the network protocol, and an e-vendor interface between the e-vendor and the network to enable messages transmitted on the network according to a network protocol to be utilised by the e-vendor and to enable messages originating from the e-vendor to be transmitted onto the network according to the network protocol, and wherein each of the e-customer and e-vendor interfaces has a first and second sub-interface, the first sub-interface enabling messages relating to the contract formation phase of a transaction to be transmitted onto the network and utilised by the respective e-customer or e-vendor and the second sub-interface enabling messages relating to the contract execution phase of a transaction to be transmitted onto the network and utilised by the respective e-customer or e-vendor.

Thus such an architecture enables an e-service to be provided according to the method of the first aspect of the invention. The architecture may include at least one additional service provider involved in the e-transaction during one of the contract negotiation phase and the contract execution phase of the transaction only but which plays no part respectively in the contract execution phase or contract negotiation phase of the e-transaction. The additional service provider may include a network enabled device, which may have an interface capable of implementing a first or a second sub-interface functionality only to enable network messages relating only to the relevant phase of the e-transaction with which the additional service provider is involved to be utilised by the additional service provider or where created by the additional service provider, to enable these messages to be transmitted onto the network according to the network protocol.

Preferably the architecture includes a quality-of-service-guardian which may have an interface capable of implementing first and second sub-interface functionality to enable network messages relating to the contract formation phase of the e-transaction between the e-customer and e-vendor to be monitored and to enable network messages relating to the contract execution phase of the transaction to be monitored, the quality-of-service guardian being enabled to check whether the contract is executed according to terms of the contract.

During the contract formation phase of the transaction the e-customer and e-vendor may negotiate contract terms. The quality-of-service guardian may monitor network messages concerned with such negotiation, and thus may be enabled to act as an arbitrator in the event that any party to the transaction is in breach or is alleged by another party to be in breach of the negotiated terms.

According to a third aspect of the invention we provide an interface for an e-service which operates over a computer network and which has an e-customer and an e-vendor which negotiate during a contract formation phase of an e-transaction and in which a product or service is supplied to the e-customer during a contract execution phase of the e-transaction, the interface being either an e-customer interface between the e-customer and the network to enable messages transmitted on the network according to a network protocol to be utilised by the e-customer and to enable messages originating from the e-customer to be transmitted onto the network according to the network protocol, or an e-vendor interface between the e-vendor and the network to enable messages transmitted on the network according to a network protocol to be utilised by the e-vendor and to enable messages originating from the e-vendor to be transmitted onto the network according to the network protocol, and wherein the interface has first and second sub-interfaces, the first sub-interface enabling messages relating to the contract formation phase of a transaction to be transmitted onto the network and utilised by the respective e-customer or e-buyer and the second sub-interface enabling messages relating to the contract execution phase of a transaction to be transmitted onto the network and utilised by the respective e-customer or e-buyer.

The interface may be implemented by means of an IDL compiler and an IDL interpreter and may be provided as a hardware and/or software item for a respective C-customer's or e-vendor's network enabled device.

According to a fourth aspect of the invention we provide a network protocol for an e-service which operates over a computer network which has an e-customer and an e-vendor which negotiate during a contract formation phase of an e-transaction and in which a product or service is supplied to the e-customer during a contract execution phase of the e-transaction, the network protocol differentiating messages relating to contract formation and contract execution phases of the e-transaction and enabling messages relating to the contract formation phase of the e-transaction transmitted onto the network by the e-customer or e-vendor to be differentiated by an interface of and utilised by the respective e-vendor or e-customer.

### BRIEF DESCRIPTION OF THE DRAWINGS

The invention will now be described with reference to the accompanying drawings in which:

FIG. 1 is a schematic view of an e-service architecture in accordance with the invention;

FIG. 2 is a schematic view of an e-service which may be operated in accordance with the invention.

### DETAILED DESCRIPTION OF THE PREFERRED EMBODIMENTS

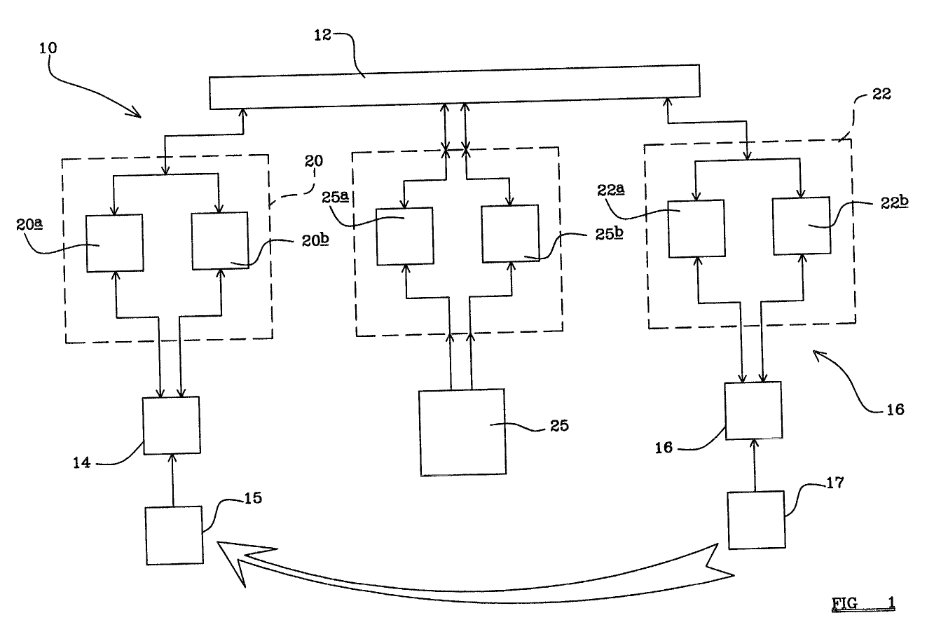

Referring to FIG. 1, a network architecture for an e-service is generally indicated at 10. The architecture includes a network 12 to which a plurality of network enabled devices mat be connected.

In this example a first network enabled device 14, e.g. a personal computer, is located at a customer's premises. The device 14, which will be referred to as an e-customer may be operated by a human 15 in order to source a product or service. In this example, which is for illustrative purposes only, the customer 15 requires the services of a printer e.g. for a bulk mailing.

A second network enabled device 16, e.g. a personal computer which will be referred to as an e-vendor, is located at the premises of a printer 17 who has a printing capability.

In a typical e-service set-up, the e-customer 14 would make an order enquiry to the e-vendor 16, during a contract formation phase of an e-transaction. This may involve for example, the e-customer 14 completing a job ticket stating for examples only, the e-customer's 14 preferences for the print job, such as the nature of the binding to be used for the pages, whether the job requires single or double-sided printing, the quality of paper to be used, the number of colours (e.g. full colour or monochrome), the desired delivery schedule, the number of copies, and the maximum price the e-customer is prepared to pay.

The e-customer 14 submits the job ticket to the e-vendor 16 over the network 12. Where the e-service is set up to allow negotiation, there may then be an exchange of messages over the network 12 between the e-customer 14 and the e-vendor 16 while they negotiate contract terms. For example the e-vendor 16 may suggest a lesser quality of paper for the print job than that originally indicated by the e-customer's preferences, in order to keep the e-customer's price preference, or an alternative delivery schedule for examples.

When the contract terms are agreed the e-customer14 confirms the order, again over the network 12 and the contract formation phase of the e-transaction is completed. It will be appreciated that preferably at least the e-vendor's 16 responses to the e-customer's 14 messages are automated according to the programming of the network enabled device 16, although the e-customer's 14 responses to alternative contract terms proposed by the e-vendor 16 may demand consideration by the human customer 15.

During the next phase of the e-transaction, the e-vendor 16 produces the product ordered by the e-customer 14 and arranges to deliver the product according to the delivery schedule specified in the contract.

It will be appreciated that the e-customer network enabled device 14 and the e-vendor network enabled device 16 may be incompatibly programmed in that the operating systems or e-service applications used by the devices 14, 16 may be incompatible. Accordingly as is well known in the art, to enable messages transmitted onto the network 12 by one party to the transaction to be utilised by the other party, there is a respective interface 20, 22 between the e-customer 14 and the network 12 and between the e-vendor 16 and the network 16.

Each interface 20, 22 includes an IDL compiler and an IDL interpreter which compile or interpret messages according to a network protocol.

In the example shown, there is an additional service provider 25 connected to the network 12 which in this example is a quality-of-service guardian enabled to monitor messages on the network 12. During the contract formation phase of the e-transaction, the quality-of-service guardian 25 monitors messages relating to the contract formation, and during the contract execution phase of the e-transaction, the quality-of-service guardian 25 monitors network messages relating to the execution of the contract.

Thus during the contract formation phase of the e-transaction, the quality-of-service guardian 25 will be made aware of the terms of the contract between the e-customer 14 and the e-vendor 16, and in the case of where there has been negotiation rather than a contract formed on the basis of straightforward “fixed price and conditions” stipulated by the e-vendor 16, the quality-of-service guardian 25 will be aware of which party proposed which alternative contract terms and when, and preferably the quality-of-service guardian 25 records such information so that the quality-of-service guardian 25 may act as an arbitrator in the event of any future dispute between the e-customer 16 and e-vendor 14 relating to the transaction.

During the contract execution phase in which the e-vendor 16 may for examples confirm to the e-customer 14 that the product has been printed and/or has been dispatched, or the e-customer 14 may seek a progress report on the print job, or may decide to change the delivery address. The quality-of-service guardian 25 may again monitor and record such messages so that in the event of a dispute arising between the e-customer 14 and the e-vendor, the quality-of-service guardian 25 may act as an independent arbitrator.

In this example, it is desirable for the quality-of-service guardian 25 to be able to monitor both messages relating to the contract formation and contract execution phases of the e-transaction, but it may be useful for the quality-of-service guardian 25 to be able readily to differentiate between contract formation and contract execution phase messages, for example so that these messages may be stored in separate storage areas for more efficient retrieval and manipulation.

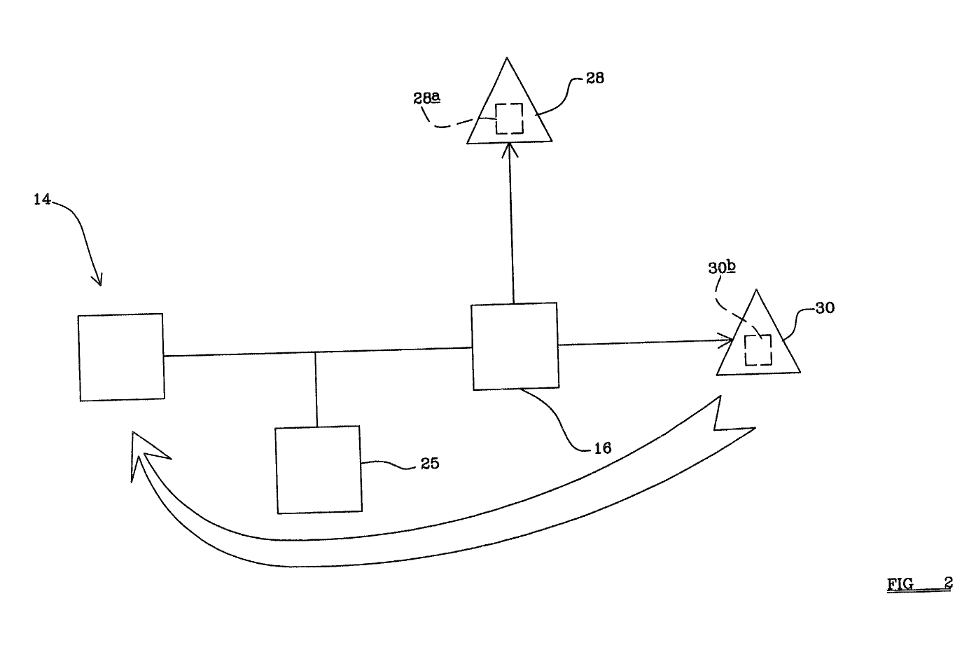

Referring now to FIG. 2 in which similar parts to those described in FIG. 1 are labelled with the same reference numerals, an e-service similar to that described above with reference to FIG. 1 is shown but the e-service involves an alternative additional service provider 28 is indicated which in this example is an insurance provider, in addition to a quality-of-service guardian 25.

The e-vendor 16, as well as providing a printing service to an e-customer 14 over the network 12, albeit using the services of a sub-contractor 30, the e-vendor 16 acts as an intermediary in selling an insurance product to the e-customer 14.

The e-customer 14 may negotiate with the e-vendor 16 in the same manner as described with reference to FIG. 1 during a contract formation phase of the transaction. However in this example, the e-vendor 16 simultaneously may negotiate with one or a plurality of print provider sub-contractors, including sub-contractor 30, and will select a sub-contractor (i.e. sub-contractor 30 in this example) which will actually produce the product and arrange to deliver it to the e-customer 14.

Also during the contract negotiation phase of the transaction, the e-vendor 16 will offer to the e-customer 14 the insurance product of the additional e-service provider 28. Whereas the e-vendor 16 may take part in any negotiation relating to the supply of the insurance product, the e-vendor 16 acts only as an intermediary such that any insurance product contract will be negotiated between the e-customer 14 and insurance product provider 28. The insurance product typically relates to the print job e-transaction, but need not necessarily do so. A typical insurance product would insure against the print job contract failing, for example a delivery schedule specified in the contract between the e-customer 14 and e-vendor 16 not being adhered to, which may cause significant commercial damage to the e-customer 14.

It will be appreciated that the insurance product provider 28, once the contract formation phase of the overall e-transaction is completed, does not need to be aware of any message relating to the contract execution phase of the e-transaction.

During the contract execution phase of the e-transaction in which the selected print provider 30 produces the printed product for the e-customer 14, to avoid the unnecessary involvement of the e-vendor 16, the e-customer 14 and the print provider 30 may communicate directly. Thus for example where the e-customer wishes to change a delivery address for the printed product, a message maybe sent by the e-customer 14 direct to the print provider 30.

Thus for a more efficient e-service operation, preferably messages relating to the contract formation phase of an e-transaction can be differentiated from messages relating to the contract execution phase of the e-transaction. Thus service providers which are involved in the e-transaction, such as the e-vendor 16, quality-of-service guardian 25, print service provider 30 and insurance product provider 28 in the example of FIG. 2, may primarily or exclusively be involved in one phase of the e-transaction only.

Referring again to FIG. 1, in accordance with the invention, the interface 20 between the e-customer 14 and the network 12, has first and second sub-interfaces 20a and 20b. Each sub-interface includes an IDL compiler and an IDL interpreter, but the first sub-interface 20a enables messages relating to the contract formation phase of the e-transaction transmitted on the network 12 according to a network protocol such as E-Speak, to be utilised by the e-customer 14 and to enable messages relating to the contract formation phase of the e-transaction originating from the e-customer 14 to be transmitted onto the network 12 according to the network protocol, whilst the second sub-interface 20b is enabled to enable messages relating to the contract execution phase of the e-transaction transmitted on the network 12 according to a network protocol to be utilised by the e-customer 14 and to enable messages relating to the contract execution phase of the e-transaction originating from the e-customer 14 to be transmitted onto the network 12 according to the network protocol.

By having such dedicated first and second sub-interfaces 20a, 20b messages relating to the contract formation phase of an e-transaction can be differentiated when transmitted onto, or retrieved from the network 12 as the respective IDL compilers can include appropriate flags, and the respective IDL interpreters can recognise such flags. Thus the network protocol used for conveying the messages on the network 12, needs to support the flagging of messages as described, so that messages relating to the different phases of an e-transaction can be differentiated.

As shown in FIG. 1, similarly the e-vendor interface 22 has first and second sub-interfaces 22a, 22b, as does the quality-of-service guardian 25 as indicated at 25a, 25b. Thus each of these are able to differentiate between messages relating to the contract formation phase and contract execution phase of the e-transaction.

Referring again to FIG. 2, it will be appreciate that the insurance provider 28 may be a network enabled device such as a personal computer and thus would require an interface 28a to enable the insurance provider to transmit messages onto the network 12 and to utilise messages received therefrom, but because the insurance provider 28 is not required to process messages relating to the contract execution phase of the e-transaction, desirably the interface 28a is first sub-interface only enabled, so that any messages relating to the contract execution phase of the transaction are ignored.

Also, where the print provider 30 communicates via the network 12 with the e-customer 14, but does not require to be involved in the contract formation phase of the e-transaction between the e-vendor 16 and the e-customer 14, an interface 30b between the print provider 30 and the network 12 may be second sub-interface only enabled. Of course where there is negotiation between the print provider 30 and the e-vendor 16, this would require the interface between the print provider 30 and the network 12 to be enabled to transmit and receive messages relating to a contract formation phase of its e-transaction with the e-vendor, but that contract is a separate e-transaction to that between the e-customer 14 and the e-vendor 16.

Alternative e-service architectures are possible. For example, the print provider 30 may simply be a proxy for another print provider in an e-supply chain so that in the event that the print provider 30 has insufficient spare capacity to print the e-customer's product, any order or order enquiry from the e-vendor 16 may be passed on to a downstream print provider.

It is envisaged that the quality-of-service guardian 25 will be enabled to establish from any messages relating to the contract execution phase of the e-transaction between the e-customer 14 and the e-vendor 16, whether there is any departure by the e-vendor 16 or e-customer 14 from the terms of the negotiated contract, and if so, may inform one or each of the parties accordingly or act as an independent arbitrator in the event of a dispute arising.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of operating a service over a computer network comprising transactions in which customers purchase products and services from vendors in return for payment, wherein a customer and a vendor negotiate during a contract formation phase of a transaction and in which a product or service is supplied to the customer during a contract execution phase of the transaction, there being an customer interface between the customer and the network to enable messages transmitted on the network according to a network protocol to be utilised by the customer, and to enable messages originating from the customer to be transmitted onto the network according to the network protocol, and an vendor interface between the vendor and the network to enable messages transmitted on the network according to a network protocol to be utilised by the vendor and to enable messages originating from the vendor to be transmitted onto the network according to the network protocol, and wherein the method includes differentiating messages relating to contract formation and contract execution phases of the transaction, messages relating to the contract formation phase of the transaction being enabled for transmission onto the network or for utilisation by the customer or vendor by a first sub-interface of the respective customer or vendor interface, and messages relating to the contract execution phase of the transaction being enabled for transmission onto the network or for utilisation by the customer or vendor by a second sub-interface of the respective customer or vendor interface.

2. A method according to claim 1 wherein an additional service provider is involved in the transaction during the contract negotiation phase of the transaction only and plays no part in the contract execution phase of the transaction, there being an interface between the additional service provider and the network, the method including implementing a first sub-interface functionality only to enable network messages relating only to the contract formation phase of the transaction to be utilised by the additional service provider or where created by the additional service provider, to enable these messages to be transmitted onto the network according to the network protocol.

3. A method according to claim 1 wherein an additional service provider is involved in the transaction during the contract execution phase of the transaction only and plays no part in the contract formation phase of the transaction, there being an interface between the additional service provider and the network, the method including implementing a second sub-interface functionality only to enable network messages relating only to the contract execution phase of the transaction to be utilised by the additional service provider or where created by the additional service provider, to enable these messages to be transmitted onto the network according to the network protocol.

4. A method according to claim 1 wherein an additional service provider which is involved in the transaction during the contract negotiation phase of the transaction and the contract execution phase of the transaction, there being an interface between the additional service provider and the network, the method including implementing first and second sub-interface functionality to enable network messages relating to the contract formation and execution phases of the transaction to be utilised by the additional service provider or where created by the additional service provider, to enable these messages to be transmitted onto the network according to the network protocol.

5. An architecture for an service which operates over a computer network which has an customer and an vendor which negotiate during a contract formation phase of a transaction and in which a product or service is supplied to the customer during a contract execution phase of the transaction, there being an customer interface between the customer and the network to enable messages transmitted on the network according to a network protocol to be utilised by the customer and to enable messages originating from the customer to be transmitted onto the network according to the network protocol, and an vendor interface between the vendor and the network to enable messages transmitted on the network according to a network protocol to be utilised by the vendor and to enable messages originating from the vendor to be transmitted onto the network according to the network protocol, and wherein each of the customer and vendor interfaces has a first and second sub-interface, the first sub-interface enabling messages relating to the contract formation phase of a transaction to be transmitted onto the network and utilised by the respective customer or vendor and the second sub-interface enabling messages relating to the contract execution phase of a transaction to be transmitted onto the network and utilised by the respective customer or vendor.

6. A method according to claim 5 wherein the architecture include at least one additional service provider involved in the transaction during one of the contract negotiation phase and the contract execution phase of the transaction only but which plays no part respectively in the contract execution phase or contract negotiation phase of the transaction.

7. An architecture according to claim 6 wherein the additional service provider includes a network enabled device which has an interface capable of implementing a first or a second sub-interface functionality only to enable network messages relating only to the relevant phase of the transaction with which the additional service provider is involved to be utilised by the additional service provider or where originating from the additional service provider, to enable these messages to be transmitted onto the network according to the network protocol.

8. An architecture according to claim 5 wherein the architecture includes a quality-of-service-guardian which has an interface capable of implementing first and second sub-interface functionality to enable network messages relating to the contract formation phase of the transaction between the customer and vendor to be monitored and to enable network messages relating to the contract execution phase of the transaction to be monitored, the quality-of-service guardian being enabled to check whether the contract is executed according to terms of the contract.

9. An architecture according to claim 8 wherein in the service, during the contract formation phase of the transaction, the customer and vendor negotiate contract terms, the quality-of-service guardian monitoring network messages concerned with such negotiation, and being enabled to act as an arbitrator in the event that any party to the transaction is in breach or is alleged by another party to be in breach of the negotiated terms.

10. An interface for a service which operates over a computer network and which has an customer and an vendor which negotiate during a contract formation phase of a transaction and in which a product or service is supplied to the customer during a contract execution phase of the transaction, the interface being either an customer interface between the customer and the network to enable messages transmitted on the network according to a network protocol to be utilised by the customer and to enable messages originating from the customer to be transmitted onto the network according to the network protocol, or an vendor interface between the vendor and the network to enable messages transmitted on the network according to a network protocol to be utilised by the vendor and to enable messages originating from the vendor to be transmitted onto the network according to the network protocol, and wherein the interface has first and second sub-interfaces, the first sub-interface enabling messages relating to the contract formation phase of a transaction to be transmitted onto the network and utilised by the respective customer or buyer and the second sub-interface enabling messages relating to the contract execution phase of a transaction to be transmitted onto the network and utilised by the respective customer or buyer.

11. An interface according to claim 10 wherein the interface includes an IDL compiler and an IDL interpreter provided as a hardware and/or software item for a respective customer's or vendor's network enabled device.

12. A network protocol for a service which operates over a computer network which has an customer and an vendor which negotiate during a contract formation phase of a transaction and in which a product or service is supplied to the customer during a contract execution phase of the transaction, the network protocol differentiating messages relating to contract formation and contract execution phases of the transaction and enabling messages relating to the contract formation phase of the transaction transmitted onto the network by the customer or vendor to be differentiated by an interface of and utilised by the respective vendor or customer.
